(19) United States
(12) Patent Application Publication
(10) Pub. No.: US 2006/0093410 A1
(43) Pub. Date: May 4, 2006

(54) Image forming apparatus and method for controlling the same

(75) Inventor: Shigeo Hata, Toride-shi (JP)

Correspondence Address: Canon U.S.A. Inc.,;Intellectual Property Division, 15975 Alton Parkway, Irvine, CA, 92618-3731, US

(73) Assignee: Canon Kabushiki Kaisha, Ohta-ku (JP)

(21) Appl. No.: 11/258,299

(22) Filed: Oct. 25, 2005

(30) Foreign Application Priority Data
Oct. 29, 2004 (JP) 2004-317029

(51) Int. Cl. G03G 15/01

(52) U.S. Cl. 399/302

(57) ABSTRACT

An image forming apparatus includes an intermediate transfer belt, a driving roller for revolving the intermediate transfer belt, a belt conveyer unit including at least one driving motor for driving the driving roller, an encoder, and a system controller. The encoder detects the rotation speed of the driving roller. The system controller detects a value of the integral of a temporary change in the detected rotation speed and changes, on the basis of the detected integral value, the rotation speed of the driving roller by the integral value in a direction opposite to the temporary change immediately after the temporary change occurs or immediately after the temporary change ends.

### BACKGROUND OF THE INVENTION

1. Field of the Invention

The present invention generally relates to an image forming apparatus, a method for controlling the image forming apparatus, and a control program for the same. In particular, the present invention relates to an image forming apparatus including a belt conveyer unit having a belt, a driving roller for rotating the belt, and a driving motor for driving at least the rotation of the driving roller, a method for controlling the image forming apparatus, and a program for causing a computer to execute the method for controlling the image forming apparatus.

2. Description of the Related Art

FIGS. 9A and 9B illustrate a block diagram of an image forming apparatus for forming a color image, where FIG. 9A illustrates the mechanical structure of an image forming section and FIG. 9B schematically illustrates the system architecture of the image forming apparatus.

As shown in FIG. 9A, an image forming section 123 includes four image forming units for forming, for example, Y (yellow), M (magenta), C (cyan), K (black) color images. For example, the image forming unit for forming an image of Y color includes a photoconductor drum 105, a developer unit 106, a cleaner 107, a charger 108, a primary transfer roller 109, and a laser optical system 110. The image forming units for forming images of M, C, and K colors have the same structure as that of the image forming unit for forming an image of Y color. Each of the image forming units forms an image of the corresponding color on an intermediate transfer belt 101.

The image forming operation of the image forming section 123 is controlled by a system controller 120 shown in FIG. 9B. Color image data delivered from an image scanning unit 121 or an image processing apparatus 122 is supplied to each of the image forming units for a different color via the system controller 120. On the photoconductor drum in each image forming unit, an optical semiconductor layer that is subject to a change in an electrical characteristic in response to irradiation of light is formed. Each of the photoconductor drums rotates at a constant speed when forming an image and each of the image forming units carries out the following operations (1) through (5) (hereinafter, for exemplary purposes, operations with respect to the Y color image forming unit are described):

(1) Charging: the charger 108 uniformly charges the optical semiconductor layer on the photoconductor drum 105.

(2) Laser Exposure: the laser optical system 110 emits a laser beam to the photoconductor drum 105 so as to form an image pattern (latent image) on the photoconductor drum 105.

(3) Development: the developer unit 106 deposits toner to the latent image on the photoconductor drum 105.

(4) Primary transfer: the primary transfer roller 109 transfers a toner image from the photoconductor drum 105 onto the intermediate transfer belt 101.

(5) Cleaning: the cleaner 107 cleans the toner which is not transferred onto the intermediate transfer belt 101 from the photoconductor drum 105.

In the following operations (6) and (7), the toner image transferred to the intermediate transfer belt 101 is transferred to a recording paper sheet and is fixed.

(6) Secondary Transfer: a secondary transfer unit 111 transfers the toner image on the intermediate transfer belt 101 onto a recording paper sheet.

(7) Fixing: a fuser unit (a fixing unit) 112 fixes the toner on the recording paper sheet by applying heat and pressure to the recording paper sheet, and then outputs the recording paper sheet to outside the image forming unit.

As described above, toner images formed by the individual image forming units are sequentially and synchronously transferred onto the intermediate transfer belt 101 one on top of the other.

However, if the moving speed of the intermediate transfer belt 101 varies, the transfer positions of the toner images formed by the individual image forming units are shifted from their proper positions. Thus, image quality degradation, such as a color registration error (error at a primary transfer position) or uneven density, occurs.

As shown in FIG. 9A, the intermediate transfer belt 101 is driven by the rotation of a driving roller 104 to rotate in a direction shown by arrow A. The driving torque of a driving motor 102 is transferred to the driving roller 104 via a driving gear 103.

Next, the transport speed, which is a moving speed of the intermediate transfer belt 101, is described. Let the radius of the driving roller 104 be r, the thickness from the surface to the neutral line of the intermediate transfer belt 101 be d0, and the angular velocity of the driving roller 104 be ω. Then, a transport speed Vb of the intermediate transfer belt 101 is expressed as follows:
Vb=(r+d0)×ω (1)

Main factors that cause variance of the transport speed Vb of the intermediate transfer belt 101 in an actual system are described next. The main factors include an eccentric component Δr of the driving roller 104, a thickness irregularity Δd of the intermediate transfer belt 101 (caused by the manufacture of a seamless belt), and an angular velocity variation Δω of the driving roller 104 caused by an eccentric component of the driving gear 103. When these factors are taken into consideration, the transport speed Vb can be expressed by the following equation (2):
Vb=(r+Δr+Δd)×(ω+Δω)=rω+Δrω+Δdω+(r+Δr+Δd)×Δω (2)

Accordingly, the speed variation component ΔVb(=Vb−rω) can be expressed by the following equation (3):
ΔVb=Δrω+Δdω+Δω×(r+Δr+Δd)=ΔVr+ΔVd+ΔVω (3)
where ΔVr=Δrω, ΔVd=Δdω, and ΔVω=Δω×(r+Δr+Δd).

Here, ΔVr represents the speed variation caused by the eccentric component Δr of the driving roller 104, ΔVd represents the speed variation caused by the thickness irregularity Δd of the intermediate transfer belt 101, and ΔVω represents the speed variation caused by the angular velocity variation Δω of the driving roller 104.

In terms of the speed variation ΔVr caused by the eccentric component Δr of the driving roller 104, the mechanical structure of the image forming section 123 is designed so that the sum of a distance D1 between the upper contact point of the driving roller 104 and the intermediate transfer belt 101 and the transfer point of the Y (yellow) photoconductor drum and distances D2 to D4 between the other photoconductor drums is an integral multiple of the circumferential length of the driving roller 104. This design can reduce the impact of the speed variation ΔVr on the color registration error at the primary transfer time.

The speed variation ΔVd caused by the thickness irregularity Δd of the intermediate transfer belt 101 is described next. A single photoconductor drum forms a plurality of predetermined patterns on the intermediate transfer belt 101 at predetermined intervals. Each of the predetermined patterns formed on the intermediate transfer belt 101 is detected at a given position on the revolution route of the intermediate transfer belt 101. The thickness irregularity Δd of the intermediate transfer belt 101 is detected on the basis of the time differences between the detection timings. Japanese Patent Laid-Open No. 10-186787 (corresponding to U.S. Pat. No. 6,038,423) discusses a method for controlling the rotation speed of the driving roller 104 or controlling the optical writing position on each photoconductor drum by using the detected thickness irregularity Δd.

In terms of the speed variation ΔVω caused by the angular velocity variation Δω of the driving roller 104, an encoder is mounted on a shaft of the driving roller 104. The driving frequency of the driving roller 104 is calculated on the basis of the detection signal of the encoder. A technique for correcting the angular velocity variation of the driving roller 104 using the driving frequency has been widely used.

Additionally, in terms of the speed variation ΔVr caused by the eccentric component Δr of the driving roller 104 and the speed variation ΔVω caused by the angular velocity variation Δω of the driving roller 104, the speed variation is corrected by the mechanical structure of a drive system. Japanese Patent Laid-Open No. 2003-29483 (corresponding to U.S. Pat. No. 6,771,919) discusses this technique.

Furthermore, if a disturbance shock occurs during the image forming operation, the disturbance shock causes an instant speed variation in the transport speed Vb of the intermediate transfer belt 101. As a result, a color registration error or uneven density occurs. An image forming apparatus disclosed in Japanese Patent Laid-Open No. 10-186787 controls a drive system with a feedback control technique using the output of an encoder. Additionally, an image forming apparatus disclosed in Japanese Patent Laid-Open No. 2003-29483 detects load variation occurring in a drive system of the intermediate transfer belt 101 and corrects the eccentricity by controlling a drive system with a feed forward control technique.

However, Japanese Patent Laid-Open No. 10-186787 does not provide a detailed description of the feedback control of the drive system. Therefore, the reference appears to not teach how to perform the control of the drive system.

The image forming apparatus disclosed in Japanese Patent Laid-Open No. 2003-29483 corrects the eccentricity by improving the mechanical structure of the drive system, and therefore, the cost of the image forming apparatus inevitably increases. Additionally, since the image forming apparatus corrects the variation in a transport speed of the intermediate transfer belt 101 caused by the disturbance shock by feed forward control, the correction of the variation in a transport speed is difficult for a shock with low reproducibility.

### SUMMARY OF THE INVENTION

The present invention provides an image forming apparatus, a method for controlling the image forming apparatus, and a program capable of forming an image having a superior image quality even when a transport speed change of an intermediate transfer belt occurs due to a disturbance shock while forming an image.

According to an embodiment of the present invention, an image forming apparatus includes a belt, a driving roller configured to revolve the belt, a belt conveyer unit including at least one driving motor configured to drive the rotation of the driving roller, a rotation speed detection unit configured to detect the rotation speed of the driving roller, a change amount detection unit configured to detect an amount of temporary change in the rotation speed detected by the rotation speed detection unit, and a correction unit configured to correct the rotation speed of the driving roller by the amount of temporary change in a direction opposite to a change direction of the temporary change on the basis of the amount of temporary change detected by the change amount detection unit.

According to another embodiment of the present invention, a method of driving an image forming apparatus is provided. With respect to this embodiment, an exemplary image forming apparatus may include a belt, a driving roller configured to revolve the belt, and a belt conveyer unit having at least one driving motor configured to drive the rotation of the driving roller. The method includes the steps of detecting the rotation speed of the driving roller, detecting an amount of temporary change in the rotation speed detected in the step of detecting the rotation speed of the driving roller, and correcting the rotation speed of the driving roller by the amount of temporary change in a direction opposite to a change direction of the temporary change on the basis of the amount of temporary change detected in the step of detecting an amount of temporary change in the rotation speed.

According to another embodiment of the present invention, an image forming apparatus configured to form a color image includes a plurality of rotators configured to form a color image by rotating in cooperation with each other, a detection unit configured to detect an amount of change in the rotation speed of the rotators, the change in the rotation speed degrading the quality of the color image, and a rotation speed correction unit configured to correct the rotation speed of the rotators so as to cancel a value of the integral of the change detected by the detection unit.

According to another embodiment of the present invention, a computer readable medium containing computer-executable instructions for driving an image forming apparatus is provided. The image forming apparatus may include a belt, a driving roller configured to revolve the belt, and a belt conveyer unit including at least one driving motor configured to drive the rotation of the driving roller. The computer readable medium includes computer-executable instructions for detecting a rotation speed of the driving roller; computer-executable instructions for detecting an amount of temporary change in the rotation speed; and computer-executable instructions for correcting the rotation speed of the driving roller by an amount about equivalent to the detected amount of temporary change in a direction opposite to a direction of the temporary change.

The foregoing features can be achieved by combinations of the features defined in the appended independent claims. The appended dependent claims define further advantageous and exemplary combinations of the present invention.

The foregoing summary is not intended to be inclusive of all the features of the present invention. Therefore, it is apparent that any subcombination of the features herein is also included within the scope of the present invention.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A and 1B illustrate an exemplary mechanical structure and system architecture of an electrophotographic image forming apparatus according to an embodiment of the present invention.

FIG. 2 illustrates a block diagram of exemplary components of an image forming unit, a belt conveyer control unit, and a system controller.

FIG. 3 is a diagram for illustrating a relationship among various data tables generated by the system controller and further stored in a RAM.

FIG. 4 is a flow chart of the procedure of rotation speed control, according to an embodiment of the present invention.

FIGS. 5A and 5B illustrate a predetermined pattern formed on an intermediate transfer belt and a detection signal output from an image scanning sensor when the image scanning sensor detects the predetermined pattern, according to a first embodiment of the present invention.

FIG. 6 is a diagram illustrating a case where a disturbance shock occurs, according to the first embodiment.

FIG. 7 is a block diagram illustrating the architecture of a feedback control, unit according to the first embodiment.

FIG. 8 is a flow chart illustrating an exemplary operating procedure of the feedback control unit.

FIGS. 9A and 9B illustrate a block diagram of a known image forming apparatus for forming a color image.

### DESCRIPTION OF THE EMBODIMENTS

### First Exemplary Embodiment

Exemplary embodiments of the present invention are described with reference to the accompanying drawings. The following description of exemplary embodiments is merely illustrative in nature and is in no way intended to limit the invention, its application, or uses. All of the features and the combinations thereof described in the embodiment are not necessarily essential to the invention. For example, while the exemplary embodiments of the present invention are described with reference to an image forming apparatus including a single photoconductor drum, the single-photoconductor-drum mechanism is not intended to be limited to such applications. For example, an image forming apparatus including Y, M, C, and K image forming units arranged in the feed direction of a recording paper sheet would fall within the intended scope of the exemplary embodiments.

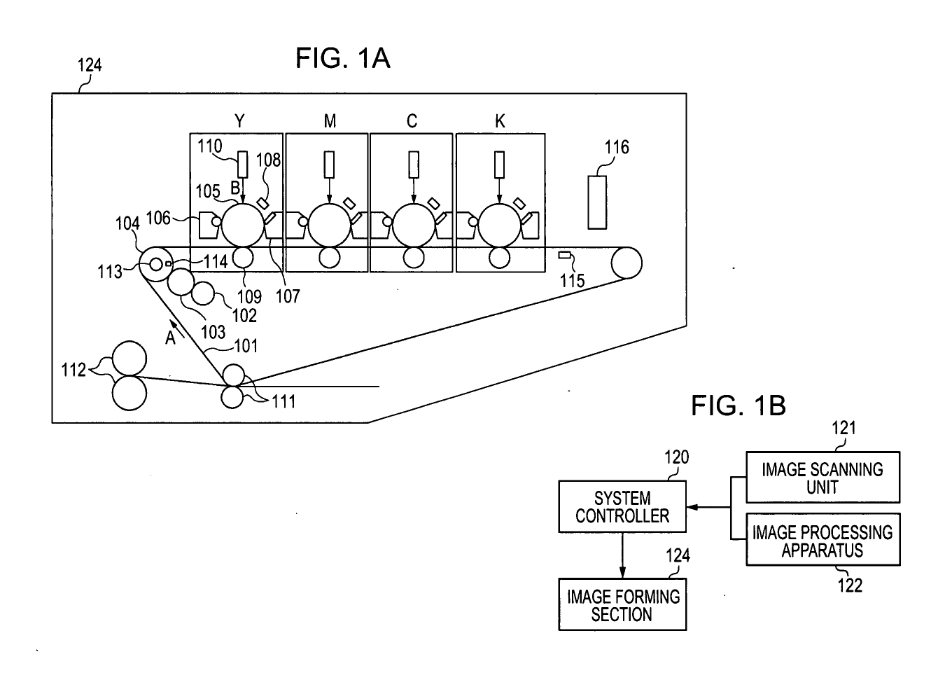

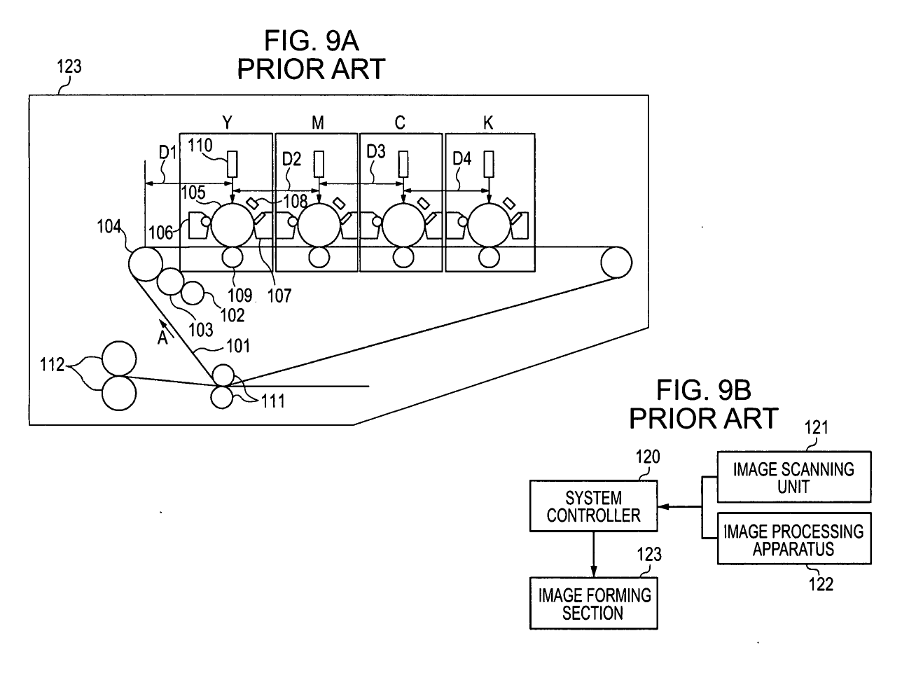

FIGS. 1A and 1B illustrate the mechanical structure and system architecture of an electrophotographic image forming apparatus according to an embodiment of the present invention. This image forming apparatus is an image forming apparatus for forming a color image and is similar to the known image forming apparatus shown in FIGS. 9A and 9B. Accordingly, identical elements to those illustrated and described in relation to FIGS. 9A and 9B are designated by identical reference numerals, and therefore, the descriptions are not repeated here.

As shown in FIG. 1A, an encoder 113 detects a plurality of marks disposed on a rotating surface of the driving roller 104 in a concentric fashion and outputs a signal indicating the angular velocity of the rotation. A driving roller home position sensor 114 detects a rotation reference position (home position) provided at a predetermined position on the rotating surface of the driving roller 104. A belt home position sensor 115 detects a home position provided at a predetermined revolution position on the intermediate transfer belt 101. An image scanning sensor 116 detects a predetermined pattern (toner image) formed on the intermediate transfer belt 101.

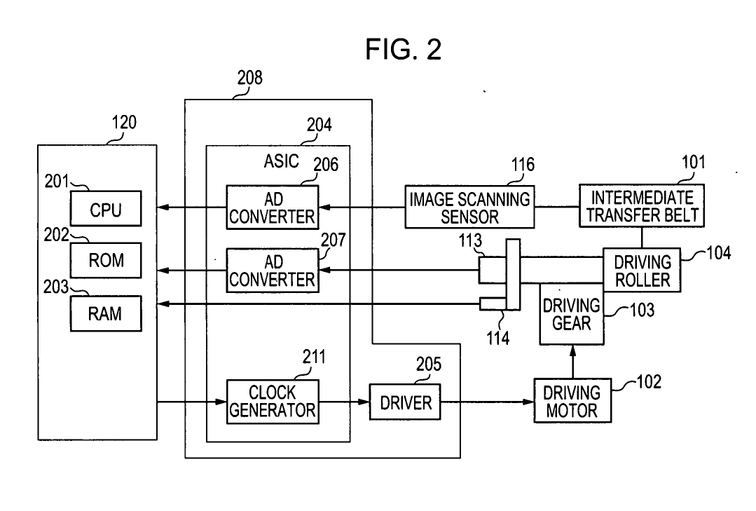

FIG. 2 illustrates a block diagram of components of an image forming section 124 shown in FIGS. 1A and 1B, a belt conveyer control unit 208 for controlling the operation of the intermediate transfer belt 101, and a system controller 120. The belt conveyer control unit 208 includes an application specific IC (ASIC) 204 and a driver 205.

The system controller 120 includes a central processing unit (CPU) 201, a read only memory (ROM) 202, and a random access memory (RAM) 203. The CPU 201 carries out image forming processing under the control of a program stored in the ROM 202. The RAM 203 provides a working area of the CPU 201.

The ASIC 204 includes an AD converter 206 for converting an analog signal delivered from the image scanning sensor 116 to a digital signal and an AD converter 207 for converting an analog signal delivered from the encoder 113 to a digital signal. The digital data converted from the analog signals are delivered to the system controller 120. The output signal from the driving roller home position sensor 114 is directly transmitted to the system controller 120. Although not shown, a signal indicating the predetermined revolution position on the intermediate transfer belt 101 is also directly transmitted from the belt home position sensor 115 to the system controller 120.

The ASIC 204 further includes a clock generator 211 for driving the driving motor 102 (a stepping motor in this embodiment). The clock generator 211 generates a clock signal of a predetermined driving frequency and delivers it to the driver 205 under the control of the CPU 201. Upon receiving the clock signal, the driver 205 generates a driving clock of a predetermined driving frequency and outputs it to the driving motor (stepping motor) 102 in order to drive the driving motor 102.

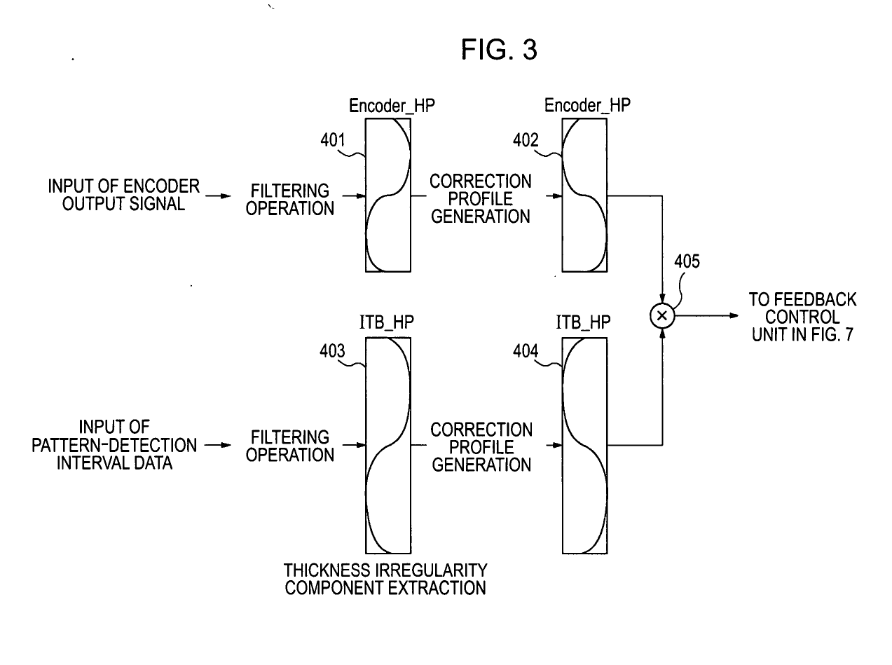

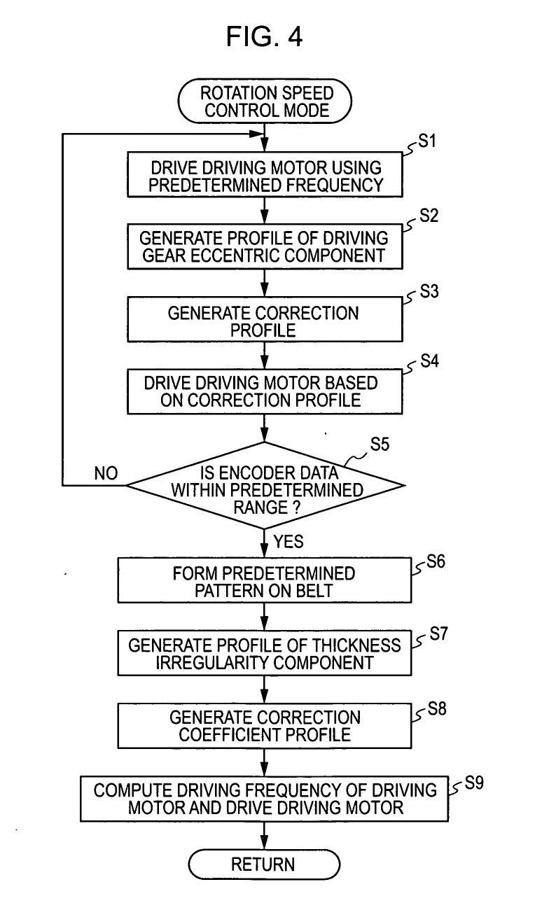

The control of the rotation speed of the driving motor 102 by the system controller 120 is described next. FIG. 3 is a diagram for illustrating a relationship among various data tables generated by the system controller 120 and stored in the RAM 203. While, FIG. 4 is a flow chart illustrating an exemplary procedure of rotation speed control of the driving motor 102 by the system controller 120. The process shown by the flow chart of FIG. 4 is described below with reference to FIG. 3.

The driving motor 102 is driven using a driving clock of a predetermined driving frequency f (step S1). At the same time, in order to extract an eccentric component of the driving gear 103, the CPU 201 appropriately performs a low-frequency bandpass digital filtering process on a rotation angular velocity signal from the driving roller 104 on the basis of a digital signal, representing the rotation angular velocity of the driving roller 104, detected by the encoder 113 and transmitted from the ASIC 204 and a detection signal of the rotation reference position (home position) of the driving roller 104 transmitted from the driving roller home position sensor 114. The CPU 201 then generates a data table 401 from the eccentric component extracted for one revolution of the driving roller 104 and stores the data table 401 in the RAM 203 (step S2). The number of entries of the eccentric component data in the data table 401 is identical to the number of samples (the number of detected marks) output from the encoder 113 during one revolution of the driving roller 104. A sine-wave profile generated from the eccentric component data of the driving gear 103 in the data table 401 schematically indicates the speed variation for one revolution of the driving roller 104.

In order to correct the eccentric component of the driving gear 103, the CPU 201 generates a correction profile for one revolution of the driving roller 104 on the basis of the speed variation profile stored in the data table 401 and stores the correction profile in the RAM 203 as a drive table 402 (step S3). The CPU 201 then drives the driving motor 102 while correcting the rotation of the driving motor 102 on the basis of the drive table 402 and a rotation angular velocity signal of the driving roller 104 detected by the encoder 113 (step S4).

In the correction process, the CPU 201 determines whether the rotation angular velocity of the driving roller 104 detected by the encoder 113 is within a predetermined range (step S5). It is noted that the predetermined range depends on the speed variation that the image forming apparatus aims to achieve. For example, assuming that the driving frequency of the driving motor 102 is 6 kHz, the gear ratio of the driving gear 103 is 5, the center value of rotation frequency of the driving roller 104 detected by the encoder 113 is 1.2 kHz, and the allowed margin of error is 0.1%, the predetermined range is determined to be 1.2 kHz±0.1%. If it is determined that the rotation angular velocity is within the predetermined range, the process proceeds to step S6. Otherwise, the process returns to step S1, where the CPU 201 retrieves the correction profile again.

At step S6, it is determined that the rotation angular velocity of the driving roller 104 is stable, and therefore, a predetermined pattern is formed on the intermediate transfer belt 101. That is, the predetermined pattern is formed by transferring a toner image having a predetermined shape formed on the photoconductor drum 105 onto the intermediate transfer belt 101.

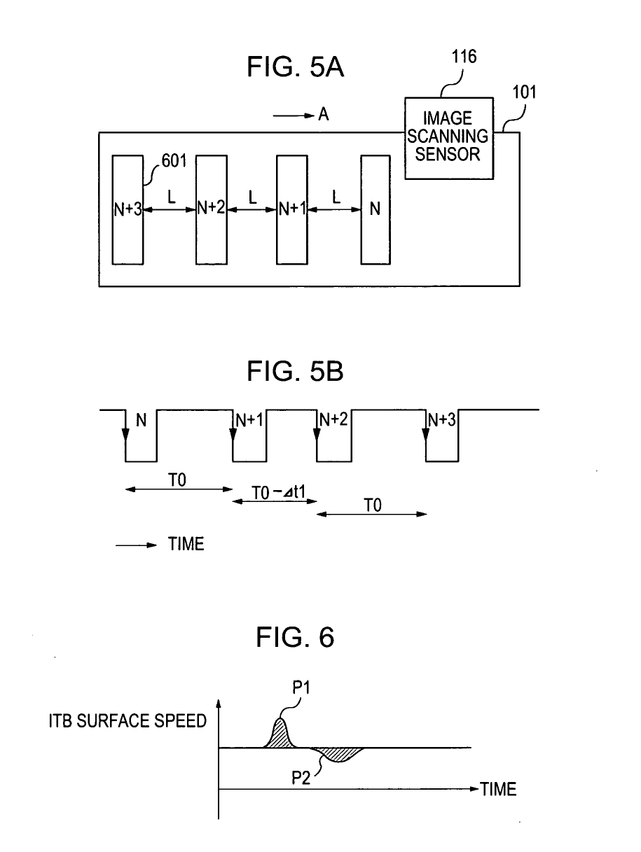

FIG. 5A illustrates the predetermined pattern to be formed on the intermediate transfer belt 101. FIG. 5B illustrates a detection signal output from the image scanning sensor 116 when the image scanning sensor 116 detects the predetermined pattern. A plurality of the predetermined patterns 601 (N to N+3) is formed on the intermediate transfer belt 101 while being evenly spaced by distance L. When the intermediate transfer belt 101 having the plurality of predetermined patterns thereon moves in a direction shown by arrow A, the image scanning sensor 116 facing the intermediate transfer belt 101 detects the plurality of predetermined patterns. Thus, the image scanning sensor 116 outputs a detection signal shown in FIG. 5B.

Assuming that the moving speed of the intermediate transfer belt 101 is Vₜ and the time interval between outputs of the detection signals from the image scanning sensor 116 is T0, when the moving speed Vₜ is constant, the following equation (4) is obtained:
L/Vₜ=T0 (4)

In contrast, when the moving speed Vt of the intermediate transfer belt 101 varies, equation (4) is expressed as follows:
L/(T0±ΔT)=Vₜ±ΔV (5)
where ΔT is a variation of the time interval T0 caused by a variation of the moving speed Vₜ, and ΔV is a variation of the moving speed Vₜ.

The interval (T0±ΔT) between outputs of the image scanning sensor 116 is acquired as a counter value of a timer incorporated in the ASIC 204. The CPU 201 appropriately performs a low-frequency bandpass digital filtering process on a plurality of the acquired time intervals (T0±ΔT) to extract thickness irregularities of the intermediate transfer belt 101. The CPU 201 generates a data table 403 (see FIG. 3) from the thickness irregularities for one revolution of the driving roller 104 and stores the data table 403 in the RAM 203 (step S7). The number of entries of the thickness irregularity data in the data table 403 is identical to the number of the predetermined patterns detected by the image scanning sensor 116. A sine-wave profile generated from the thickness irregularity data of the intermediate transfer belt 101 in the data table 403 schematically indicates the speed variation for one revolution of the intermediate transfer belt 101.

In order to correct the thickness irregularities, the CPU 201 then generates a correction coefficient profile 404 (see FIG. 3) on the basis of the sine-wave profile (step S8). When the belt home position sensor 115 detects the predetermined revolution position (home position) of the intermediate transfer belt 101, a multiplier 405 (see FIG. 3) multiplies a motor driving frequency calculated from the drive table 402 by the thickness irregularity correction coefficient g read from the correction coefficient profile 404 so as to obtain a corrected motor driving frequency f′=g×(T0±ΔT). The multiplier 405 delivers the corrected motor driving frequency to a feedback control unit (step S9).

It is noted that the method for detecting the moving speed of the intermediate transfer belt 101 is not limited to the above-described embodiment. For example, in addition to the above-described embodiment, a method is known in which the thickness irregularity is measured in advance by a measurement unit and a profile is calculated on the basis of the measured values. Alternatively, the predetermined pattern formed on the intermediate transfer belt 101 may be a mark pre-written on the belt in place of the toner image and the mark may be detected.

The feedback correction carried out during the image forming operation is described next. FIG. 6 is a diagram illustrating a moving speed variation of the intermediate transfer belt 101 and the correction thereof when a disturbance shock occurs during an image forming operation.

In FIG. 6, the ordinate represents the moving speed of the intermediate transfer belt (ITB) 101 and the abscissa represents the time. Basically, the moving speed of the intermediate transfer belt 101 is constant. However, if a disturbance shock occurs, an instant moving speed variation P1 of the intermediate transfer belt 101 appears. This moving speed variation P1 causes an image positional shift ΔS, which corresponds to an area (accumulation value or integration value) shown by cross hatchings in FIG. 6. The image positional shift ΔS does not disappear until the predetermined revolution position (home position) on the intermediate transfer belt 101 is detected next time. Therefore, immediately after the shock ends, a speed correction value P2 that is the same as the area shown by hatchings of P1 is added to the speed in the opposite direction. That is, the rotation speed of the driving roller is changed by a correction value identical to the accumulation value in a direction opposite to that of the instant variation. Thus, the image positional shift caused by the moving speed variation of the intermediate transfer belt 101 due to the disturbance shock can be corrected.

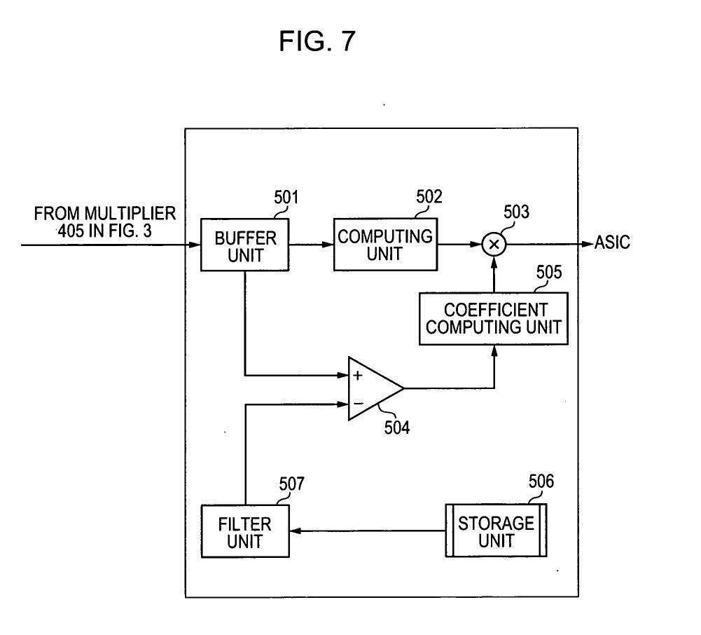

The feedback control unit is now herein described below with reference to FIG. 7. FIG. 7 is a block diagram illustrating the structure of the feedback control unit. This feedback control unit is realized by functional blocks executed by the system controller 120.

As shown in FIG. 7, a buffer unit 501 temporarily stores the target values f′ (i.e., corrected data of the motor driving frequency) sequentially output from the multiplier 405 shown in FIG. 3. The buffer unit 501 synchronizes the output timing of the target value with the input timing of a signal input to a comparison unit 504 from a filter unit 507, which is described below. A computing unit 502 converts the target value f′ read from the buffer unit 501 to PPS data, which is digital data corresponding to a driving frequency of pulses supplied to the driving motor (stepping motor) 102. A storage unit 506 stores rotation angular velocity data of the driving roller 104 (see FIG. 2) delivered from the encoder 113. The filter unit 507 carries out a filtering process on the rotation angular velocity data read from the storage unit 506. The comparison unit 504 compares the output from the filter unit 507 with the output from the buffer unit 501. A coefficient computing unit 505 outputs a coefficient for increasing or decreasing the output data from the computing unit 502 in accordance with the comparison result of the comparison unit 504. A combination computing unit 503 multiplies the output data from the computing unit 502 by the coefficient output from the coefficient computing unit 505 and outputs the computing result to the ASIC 204.

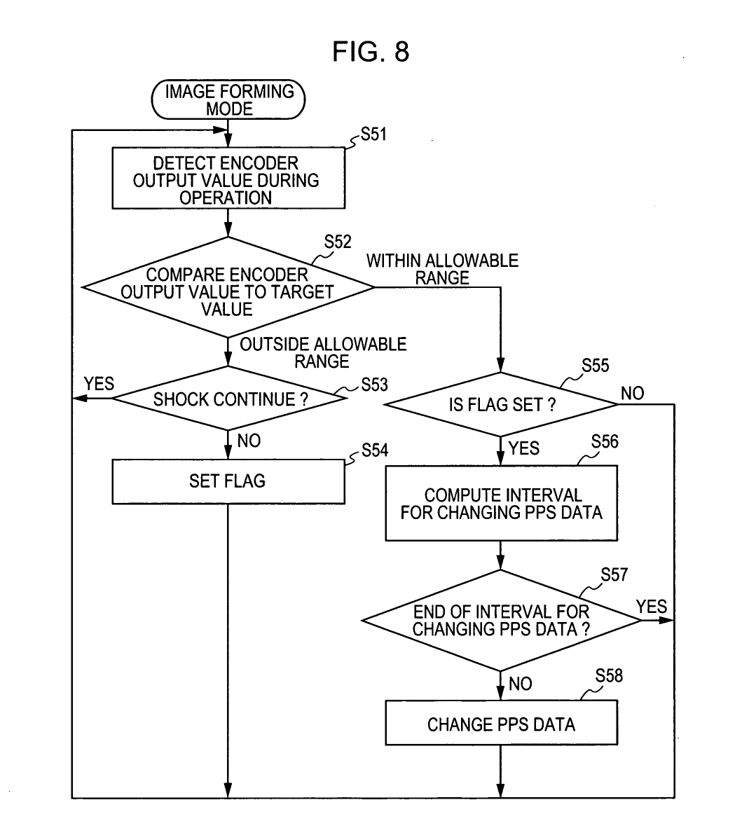

FIG. 8 is a flow chart illustrating an exemplary operating procedure of the feedback control unit. The feedback control unit temporarily stores the output value from the encoder 113 in the storage unit 506 during the image forming operation (step S51). The output value from the encoder 113 is then read out of the storage unit 506. After the noise is removed by the filter unit 507, the output value is input to the comparison unit 504. At the same time, the target value is read out of the buffer unit 501 and is input to the comparison unit 504.

The comparison unit 504 compares the two values to determine whether the output value of the operating encoder 113 is within a predetermined allowable range from the target value (step S52). It is noted that the predetermined allowable range depends on the speed variation that the image forming apparatus aims to achieve. For example, assuming that the driving frequency of the driving motor 102 is 6 kHz, the gear ratio of the driving gear 103 is 5, the center value of rotation frequency of the driving roller 104 detected by the encoder 113 is 1.2 kHz, and the allowed margin of error is ±0.1%, the predetermined allowable range is determined to be 1.2 kHz±0.1%. The comparison unit 504 also determines whether the output value of the encoder 113 is greater than or equal to the target value. If it is determined that the output value of the encoder 113 is outside the predetermined allowable range, it is determined that a disturbance shock occurs, and therefore, the process proceeds to step S53. At step S53, it is determined whether the disturbance shock continues or not. If the disturbance shock continues, the process returns to step S51. However, if the disturbance shock ends, the process proceeds to step S54. At step S54, the feedback control unit sets a flag indicating that a disturbance shock occurs.

If it is determined at step S52 that the output value of the encoder 113 is within the predetermined allowable range, the process proceeds to step S55. At step S55, the feedback control unit determines whether the flag indicating that a disturbance shock occurs is set or not. If the flag is set, the process proceeds to step S56. However, if the flag is not set, the process returns to step S51.

At step S56, a time period for correcting a speed variation caused by the disturbance shock (PPS data change period) is computed. At step S57, it is determined whether the correction was started and whether the correction time period has elapsed. If the correction time period has elapsed, the process returns to step S51. If the correction time period still remains, the process proceeds to step S58.

At step S58, the speed variation caused by the disturbance shock is corrected. That is, when the output value from the encoder during the image forming operation is greater than the target value, the coefficient computing unit 505 outputs a coefficient that generates PPS data of a low frequency. Conversely, when the output value from the encoder during the image forming operation is smaller than the target value, the coefficient computing unit 505 outputs a coefficient that generates PPS data of a high frequency. The combination computing unit 503 multiplies the coefficient by the PPS data from the computing unit 502 and outputs the computation result to the ASIC 204.

By continuously carrying out the above-described rotation speed correction control during the image forming operation, the speed variation caused by a disturbance shock can be corrected. As a result, uneven density and a color registration error can be reduced in an image formed on a paper medium and the image quality can be increased.

### Other Exemplary Embodiments

In the first exemplary embodiment, the correction control is carried out after a disturbance shock ends. However, the correction control may be started at the moment (or immediately after) the disturbance shock occurs. This scheme further reduces uneven density and a color registration error in an image formed on a paper medium and the image quality can be further increased.

The present invention can also be achieved by supplying a storage medium (or a recoding medium) storing software program code that achieves the functions of the above-described embodiments to a system or an apparatus and by causing a computer (central processing unit (CPU) or micro-processing unit (MPU)) of the system or apparatus to read and execute the software program code. In such a case, the program code itself read out of the storage medium realizes the functions of the above-described embodiments. Therefore, the storage medium storing the program code can also realize the present invention.

The functions of the above-described embodiments can be realized by another method in addition to executing the program code read out by the computer. For example, the functions of the above-described embodiments can be realized by a process in which an operating system (OS) running on the computer executes some of or all of the functions in the above-described embodiments under the control of the program code.

The present invention can also be achieved by writing the program code read out of the storage medium to a memory of an add-on expansion board of a computer or a memory of an add-on expansion unit connected to a computer. The functions of the above-described embodiments can be realized by a process in which, after the program code is written, a CPU in the add-on expansion board or in the add-on expansion unit executes some of or all of the functions in the above-described embodiments under the control of the program code.

It is further noted that the program code is only required to realize the functions of the above-described embodiments. The format of the program code may be any format. For example, the formats of the program code include object code, program code executed by an interpreter, and a script data supplied to an OS.

Examples of the recording medium for supplying the program code include a RAM, a NV-RAM (nonvolatile RAM), a flexible disk, an optical disk, an MO (magneto optical) disk, a CD-ROM (compact disk-read only memory), a CD-R (CD recordable), a CD-RW (CD-rewritable), a DVD (digital versatile disc) (i.e., a DVD-ROM (DVD-read only memory), a DVD-RAM (DVD-random access memory), a DVD-RW (DVD-rewritable), a DVD+RW (DVD-rewritable)), a magnetic tape, a nonvolatile memory card, ROM or the like. Alternatively, the program code can be supplied by downloading from another computer and a database (not shown) connected to the Internet, a commercial network, or a local area network.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-317029 filed Oct. 29, 2004, which is hereby incorporated by reference herein in its entirety.

What is claimed is:

1. An image forming apparatus comprising:
a belt;
a driving roller configured to revolve the belt;
a belt conveyer unit including at least one driving motor configured to drive the rotation of the driving roller;
a rotation speed detection unit configured to detect the rotation speed of the driving roller;
a change amount detection unit configured to detect an amount of temporary change in the rotation speed detected by the rotation speed detection unit; and
a correction unit configured to correct the rotation speed of the driving roller by the amount of temporary change in a direction opposite to a change direction of the temporary change on the basis of the amount of temporary change detected by the change amount detection unit.

2. The image forming apparatus according to claim 1, wherein the amount of temporary change is an integral value of temporary change.

3. The image forming apparatus according to claim 1, wherein the correction unit corrects the amount of temporary change immediately after the temporary change occurs or immediately after the temporary change ends.

4. The image forming apparatus according to claim 1, wherein the change amount detection unit operates after the driving motor starts and after the rotation speed of the driving roller is maintained within a predetermined speed range.

5. The image forming apparatus according to claim 1, wherein the belt is an intermediate transfer belt on which a toner image is transferred and which transfers the toner image onto a paper medium.

6. The image forming apparatus according to claim 1, further comprising:
a belt speed detection unit configured to detect a plurality of predetermined images formed on the belt and separated from each other by a predetermined distance to detect a revolution speed of the belt on the basis of the detection timings of the plurality of predetermined images;
a speed variation computing unit configured to compute a speed variation in the revolution speed of the belt detected by the belt speed detection unit; and
a determination unit configured to determine a driving frequency of the driving motor on the basis of the speed variation computed by the speed variation computing unit.

7. The image forming apparatus according to claim 6, wherein the determination unit corrects the driving frequency on the basis of the rotation speed of the driving roller detected by the rotation speed detection unit.

8. A method of driving an image forming apparatus, the image forming apparatus including a belt, a driving roller configured to revolve the belt, and a belt conveyer unit including at least one driving motor configured to drive the rotation of the driving roller, the method comprising the steps of:
detecting a rotation speed of the driving roller;
detecting an amount of temporary change in the rotation speed; and
correcting the rotation speed of the driving roller by an amount about equivalent to the detected amount of temporary change in a direction opposite to a direction of the temporary change.

9. The method according to claim 8, wherein correcting the rotation speed of the driving roller includes correcting the amount of temporary change immediately after the temporary change occurs or immediately after the temporary change ends.

10. The method according to claim 8, wherein detecting an amount of temporary change in the rotation speed is performed after the driving motor starts and after the rotation speed of the driving roller is maintained within a predetermined speed range.

11. The method according to claim 8, further comprising the steps of:
detecting a plurality of predetermined images formed on the belt and separated from each other by a predetermined distance to detect a revolution speed of the belt on the basis of the detection timings of the plurality of predetermined images;
computing a speed variation in the revolution speed of the belt; and
determining a driving frequency of the driving motor on the basis of the speed variation.

12. The method according to claim 11, wherein the step of determining a driving frequency of the driving motor corrects the driving frequency on the basis of the rotation speed of the driving roller.

13. An image forming apparatus configured to form a color image, the apparatus comprising:
a plurality of rotators configured to form a color image by rotating in cooperation with each other;
a detection unit configured to detect an amount of change in the rotation speed of the rotators, wherein the change in the rotation speed degrades the quality of the color image; and
a rotation speed correction unit configured to correct the rotation speed of the rotators so as to cancel a value of the integral of the change detected by the detection unit.

14. The image forming apparatus according to claim 13, further comprising:
a transfer belt formed by the plurality of rotators;
a plurality of developer having different colors;
a driving roller configured to revolve the transfer belt;
a driving gear configured to drive the driving roller; and
a driving motor configured to drive the driving gear,
wherein the transfer belt is configured to transfer images formed on the transfer belt with the plurality of developer onto a recording medium.

15. A computer readable medium containing computer-executable instructions for driving an image forming apparatus, the image forming apparatus including a belt, a driving roller configured to revolve the belt, and a belt conveyer unit including at least one driving motor configured to drive the rotation of the driving roller, the computer readable medium comprising:
computer-executable instructions for detecting a rotation speed of the driving roller;
computer-executable instructions for detecting an amount of temporary change in the rotation speed; and
computer-executable instructions for correcting the rotation speed of the driving roller by an amount about equivalent to the detected amount of temporary change in a direction opposite to a direction of the temporary change.

16. The computer readable medium according to claim 15, wherein correcting the rotation speed of the driving roller includes computer-executable instructions for correcting the amount of temporary change immediately after the temporary change occurs or immediately after the temporary change ends.

17. The computer readable medium according to claim 15, wherein detecting an amount of temporary change in the rotation speed is performed after the driving motor starts and after the rotation speed of the driving roller is maintained within a predetermined speed range.

18. The computer readable medium according to claim 15, further comprising:
computer-executable instructions for detecting a plurality of predetermined images formed on the belt and separated from each other by a predetermined distance to detect a revolution speed of the belt on the basis of the detection timings of the plurality of predetermined images;
computer-executable instructions for computing a speed variation in the revolution speed of the belt; and
computer-executable instructions for determining a driving frequency of the driving motor on the basis of the speed variation.

19. The method according to claim 18, wherein determining a driving frequency of the driving motor includes computer-executable instructions for correcting the driving frequency on the basis of the rotation speed of the driving roller.
